(19) United States
(12) Patent Application Publication
(10) Pub. No.: US 2026/0021492 A1
(43) Pub. Date: Jan. 22, 2026

(54) METHOD OF FLOTATION SEPARATION FOR COPPER-SULFUR POLYMETALLIC ORE

(71) Applicants: Jiangxi Copper Company Limited, Nanchang (CN); Jiangxi Copper (Dexing) Industrial Co., Ltd., Shangrao (CN)

(72) Inventors: Zhiqiang GENG, Shangrao (CN); Rixin LIU, Shangrao (CN); Zhaoyu ZHOU, Shangrao (CN); Wu XIE, Shangrao (CN); Wenhui ZHONG, Shangrao (CN); Shuanglong CHENG, Shangrao (CN); Jie XU, Shangrao (CN); Miao CHEN, Shangrao (CN); Ming DONG, Shangrao (CN); Ke XIAO, Shangrao (CN)

(21) Appl. No.: 19/232,281

(22) Filed: Jun. 9, 2025

(30) Foreign Application Priority Data
Jul. 19, 2024 (CN) 202410975196.X

(51) Int. Cl. B03D 1/01

(52) U.S. Cl. CPC B03D 1/01; B03D 2201/02; B03D 2201/06; B03D 2203/02

(57) ABSTRACT

Method of flotation separation for copper-sulfur polymetallic ore includes: S1, an ore grinding treatment is carried out on a raw ore to obtain a ground ore material with the exposure ratio of 112, 204, 312 facets of chalcopyrite of 55%-65%, 5%-18%, and 3%-10% respectively, and the exposure ratio of 100 facet of pyrite of 60%-80%; S2, the ground ore material, the collector A, the depressant B and the frother are mixed and undergo one-time roughing, so as to obtain the rougher concentrate and the rougher tailings; S3, the rougher concentrate and the collector A are mixed and undergo multiple-time cleaning to obtain the copper concentrate; and S4, the cascade-intensified flotation is carried out on the rougher tailings to obtain a sulfur-containing tailings, wherein the collector A includes

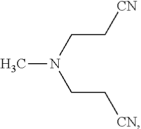

and the depressant B includes sodium cyanamide, sodium dicyandiamide, sodium polycyanamide and sodium polysulfide.

### CROSS-REFERENCE TO RELATED APPLICATIONS

The present disclosure claims the priority of Chinese Patent Application No. 202410975196X, filed with the Chinese Patent Office on Jul. 19, 2024, and entitled “METHOD OF FLOTATION SEPARATION FOR COPPER-SULFUR POLYMETALLIC ORE”, the contents of which are incorporated herein by reference in their entirety.

### TECHNICAL FIELD

The present disclosure relates to the technical field of flotation, in particular to a method of flotation separation for copper-sulfur polymetallic ore.

### BACKGROUND ART

Copper and sulfur are important metal resources in modern industry, and have important applications in the fields of chemical engineering, industrial manufacturing, fireproof materials and aerospace. Chalcopyrite is widely concerned by simultaneously containing three elements: iron, copper and sulfur. Chalcopyrite is mainly generated in polymetallic sulfide deposits and coexists with sulfide minerals such as pyrite, molybdenite, and arsenopyrite. In the process of flotation separation, due to the similarity of chemical properties of chalcopyrite and pyrite, since chalcopyrite and pyrite are easy to be oxidized and have similar floatability, the chalcopyrite concentrate is usually first obtained through preferential flotation. However, conventional collectors and depressants cannot effectively recover copper and inhibit pyrite minerals, resulting in loss of copper resources.

In view of this, the present disclosure is proposed.

### SUMMARY

The objective of the present disclosure is to provide a method of flotation separation for copper-sulfur polymetallic ore, which improves the recovery rate of copper and sulfur.

In order to achieve the above objective of the present disclosure, the following technical solution is adopted.

A method of flotation separation for copper-sulfur polymetallic ore is provided in the present disclosure, which includes the following steps:
S1, performing an ore grinding treatment on a raw ore, so as to obtain a ground ore material, wherein in the ground ore material, the exposure ratio of 112 facet of chalcopyrite is 55%-65%, the exposure ratio of 204 facet is 5%-18%, the exposure ratio of 312 facet is 3%-10%, and the exposure ratio of 100 facet of pyrite is 60%-80%;
S2, performing a slurry conditioning and a pH adjustment on the ground ore material in sequence, then adding a collector A, a depressant B and a frother into the resultant for one-time roughing, so as to obtain the rougher concentrate and the rougher tailings;
S3, mixing the rougher concentrate and the collector A and carrying out a multiple-time cleaning, so as to obtain the copper concentrate; and
S4, performing cascade-intensified flotation on the rougher tailings, so as to obtain the sulfur-containing tailings, wherein
the collector A includes

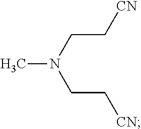

and
the depressant B includes sodium cyanamide, sodium dicyandiamide, sodium polycyanamide and sodium polysulfide.

Further, in step S1, in the raw ore, the average grade of copper is 0.2%-0.6%, and the average grade of sulfur is 1%-2%.

Further, in step S1, the ore grinding treatment includes performing first-stage ore grinding treatment and second-stage ore grinding treatment in sequence, wherein the first-stage ore grinding treatment includes semi-autogenous grinding, and the second-stage ore grinding treatment includes ball milling and/or stage grinding.

Further, in step S2 and step S4, the mass ratio of the sodium cyanamide, the sodium dicyandiamide, the sodium polycyanamide and the sodium polysulfide is (1-5):(10-17):(2-7):(1-2).

Further, in step S2, during the one-time roughing process, the addition amount of the collector A is 1000 g/t-2000 g/t, and the addition amount of the depressant B is 50 g/t-1500 g/t.

Further, in step S3, the multiple-time cleaning includes three-time cleaning or four-time cleaning.

Further, in step S3, in the first-stage cleaning and the second-stage cleaning of the multiple-time cleaning, the addition amount of the collector A is each independently 50 g/t-200 g/t. Further, in step S4, the cascade-intensified flotation includes:
performing three-time open-circuit roughing on the rougher tailings, so as to obtain open-circuit rougher concentrate; and
performing flotation on the open-circuit rougher concentrate, so as to obtain the sulfur-containing tailings, wherein the flotation includes one-time roughing, two-time cleaning and three-time scavenging.

Further, in step S4, the three-time open-circuit roughing includes: adding 10 g/t-80 g/t of the collector A for the three-time open-circuit roughing.

Further, in step S4, the one-time roughing includes: adding 10 g/t-35 g/t activator and 50 g/t-150 g/t butyl xanthate for one-time roughing; and the three-time scavenging includes adding 10 g/t-50 g/t butyl xanthate for three-time scavenging.

Compared with the prior art, the present disclosure has the following beneficial effects.

In the method of flotation separation for copper-sulfur polymetallic ore provided by the present disclosure, according to the responsiveness difference of different facets of chalcopyrite to collectors and the selective unsaturated coordination of depressants to the properties of the facets of chalcopyrite and pyrite, the differential flotation of chalcopyrite and pyrite with similar floatability is realized; so as to solve the problem of separation of chalcopyrite and pyrite in the condition of low alkalinity, thus improving the recovery rate of copper and sulfur, wherein the recovery rate of copper can reach more than 89%.

### DETAILED DESCRIPTION OF EMBODIMENTS

The technical solutions of the present disclosure will be clearly and completely described below with reference to specific embodiments, but those skilled in the art will understand that the examples described below are part of the examples of the present disclosure, rather than all of the examples, and are merely used to illustrate the present disclosure and should not be regarded as limiting the scope of the present disclosure. Based on the examples in the present disclosure, all other examples obtained by those ordinary skilled in the art without inventive work belong to the protection scope of the present disclosure. Where specific conditions are not specified in the examples, it shall be carried out according to the conventional conditions or the conditions suggested by the manufacturer. The reagents or instruments used without indicating the manufacturer are conventional products that can be obtained through commercially available purchase.

A method of flotation separation for copper-sulfur polymetallic ore is provided in the embodiments of the present disclosure, which includes the following steps:
S1, performing an ore grinding treatment on a raw ore, so as to obtain a ground ore material, wherein in the ground ore material, the exposure ratio of 112 facet of chalcopyrite is 55%-65%, the exposure ratio of 204 facet is 5%-18%, the exposure ratio of 312 facet is 3%-10%, and the exposure ratio of 100 facet of pyrite is 60%-80%;
S2, performing a slurry conditioning and a pH adjustment on the ground ore material in sequence, then adding a collector A, a depressant B and a frother into the resultant for one-time roughing, so as to obtain the rougher concentrate and the rougher tailings;
S3, mixing the rougher concentrate and the collector A and carrying out multiple-time cleaning, so as to obtain the copper concentrate; and
S4, performing cascade-intensified flotation on the rougher tailings, so as to obtain the sulfur-containing tailings, wherein
the collector A includes

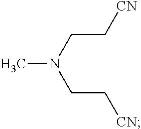

and
the depressant B includes sodium cyanamide (CAS: 17292-62-5), sodium dicyandiamide (CAS: 1934-75-4), sodium polycyanamide (molecular weight of 1000-1500) and sodium polysulfide.

The method of flotation separation for copper-sulfur polymetallic ore of the present disclosure is a method for improving the flotation efficiency of copper and sulfur based on the difference of facets.

In the present disclosure, according to the action mode of different facets of chalcopyrite and pyrite on the unsaturated coordination for collectors and depressants, the low-alkalinity recovery of readily floatable chalcopyrite and pyrite is realized, and a large amount of lime to inhibit pyrite is not required, thus reducing the copper content in sulfur-containing tailings and the consumption of lime, wherein the copper recovery rate can reach more than 89%.

For chalcopyrite, the most hydrophobic facet is the 112 facet, followed by the 204 facet. The CN group in collector A can adsorb the 112 facet of chalcopyrite. However, the inhibition ability of depressant B cannot replace the adsorption of CN group in collector A on the 112 facet of chalcopyrite, mainly because the 4-coordinated iron on the surface of chalcopyrite is replaced by the CN group in collector A to become 6-coordinated iron in the high-spin condition. At this time, the iron ions in chalcopyrite are in saturation state, weakening or reducing the mutual coordination between depressant B and chalcopyrite, thus increasing the floatability of chalcopyrite.

The atoms on 112 facet of chalcopyrite have more broken bonds, and the coordination between Cu ion and Fe ion is converted from 4-coordination to 3-coordination, both of them are in ligand deficiency, which makes them more active and easy to adsorb strongly with collector A. Iron in pyrite belongs to octahedron with 6-coordination structure, and the iron ion belongs to a low spin state, which is more easier to be oxidized under the action of collector A, so that the iron ion with 6-coordination in pyrite changes from low spin state to high spin state, and iron becomes high oxidation state iron, thus realizing the inhibition of pyrite.

In the process of multiple-time roughing, for the part of chalcopyrite that is not completely dissociated, the collector A is added. The CN group in collector A increases the contact opportunity with the 112 facet of chalcopyrite. On the other hand, by changing the ball charging scheme of semi-autogenous grinding equipment, the exposure ratios of 112 facet of chalcopyrite and 100 facet of pyrite are increased, and the pyrite is inhibited under the action of the depressant B, so that the final high-quality copper concentrate is obtained. In the process of multiple-time roughing, the collector A is easier to contact with chalcopyrite, and the depressant B is added as an auxiliary collector, so that comprehensive recovery of the hard-to-float copper ore can be realized.

In some embodiments of the present disclosure, in step S1, the raw ore includes chalcopyrite and pyrite.

In some embodiments of the present disclosure, in step S1, the average grade of copper is 0.2%-0.6%, and the average grade of sulfur is 1%-2% in the raw ore; preferably, the average grade of iron is 1.5%-2.5% in the raw ore; more preferably, the average grade of copper is 0.35%-0.45%, the average grade of sulfur is 1.55%-1.65%, and the average grade of iron is 1.95%-2.05% in the raw orc.

In some embodiments of the present disclosure, in step S1, the ore grinding treatment includes performing first-stage ore grinding treatment and second-stage ore grinding treatment in sequence, wherein the first-stage ore grinding treatment includes semi-autogenous grinding, and the second-stage ore grinding treatment includes ball milling and/or stage grinding; preferably, the duration of first-stage ore grinding treatment is 0.1h-0.2h, and the duration of second-stage ore grinding treatment is 0.15h-0.3h.

In some embodiments of the present disclosure, in step S1, in the ground ore material, the mass of solid particles with a particle size less than 0.074 mm accounts for 60%-70% of the total mass of solid particles.

According to the XRD test data, the exposure ratio of facets is determined by the ratio between the normalized peak intensities of the characteristic peaks that symbolize each facet.

In some embodiments of the present disclosure, in step S1, typically, but not limited to, for example, in the ground ore material, the exposure ratio of 112 facet of chalcopyrite can be 55%, 58%, 60%, 62%, 65%, or a range value composed of any two thereof; the exposure ratio of 204 facet of chalcopyrite can be 5%, 8%, 10%, 13%, 15%, 18%, or a range value composed of any two thereof; the exposure ratio of 312 facet of chalcopyrite can be 3%, 5%, 7%, 10%, or a range value composed of any two thereof; and the exposure ratio of 100 facet of pyrite can be 60%, 65%, 70%, 75%, 80%, or a range value composed of any two thereof.

In some embodiments of the present disclosure, the slurry conditioning includes adding water to the ground ore materials to adjust the concentration of the slurry to 30 wt %-35 wt %.

In some embodiments of the present disclosure, in step S2, the pH adjustment includes adding lime to adjust the pH of the slurry to 7-12.

In some embodiments of the present disclosure, in step S2, the mass ratio of sodium cyanamide, sodium dicyandiamide, sodium polycyanamide and sodium polysulfide is (1-5):(10-17):(2-7):(1-2); typically, but not limited to, for example, the mass ratio of sodium cyanamide, sodium dicyandiamide, sodium polycyanamide and sodium polysulfide can be 1:8:2:1, 2:8:3:1, 3:9:3:1, 4:10:5:1, 5:12:3:1, 3:15:4:1, 5:17:6:1, 4:16:6:2, 5:15:7:2.

In some embodiments of the present disclosure, in step S2, the frother includes but is not limited to pine oil.

In some embodiments of the present disclosure, in step S2, in the process of one-time roughing, the addition amount of collector A is 1000 g/t-2000 g/t; typically, but not limited to, for example, in step S2, in the process of one-time roughing, the addition amount of collector A can be 1000 g/t, 1200 g/t, 1400 g/t, 1600 g/t, 1800 g/t, 2000 g/t, or a range value composed of any two thereof.

In some embodiments of the present disclosure, in step S2, in the process of one-time roughing, the addition amount of depressant B is 50 g/t-1500 g/t; typically, but not limited to, for example, in step S2, in the process of one-time roughing, the addition amount of depressant B can be 50 g/t, 200 g/t, 500 g/t, 700 g/t, 1000 g/t, 1200 g/t, 1500 g/t, or a range value composed of any two thereof.

In some embodiments of the present disclosure, in step S2, in the process of one-time roughing, the addition amount of frother is 10 g/t-30 g/t; typically, but not limited to, for example, in step S2, in the process of one-time roughing, the addition amount of frother can be 10 g/t, 15 g/t, 20 g/t, 25 g/t, 30 g/t, or a range value composed of any two thereof.

In some embodiments of the present disclosure, in step S3, the multiple-time cleaning includes three-time cleaning or four-time cleaning.

In some embodiments of the present disclosure, in step S3, in the first-stage cleaning and the second-stage cleaning of the multiple-time cleaning, the addition amount of the collector A is each independently 50 g/t-200 g/t; preferably, in step S3, in the first-stage cleaning of the multiple-time cleaning, the addition amount of the collector A is 100 g/t-200 g/t, and in the second-stage cleaning of the multiple-time cleaning, the addition amount of collector A is 50 g/t-100 g/t.

In some embodiments of the present disclosure, in step S3, the multiple-time cleaning includes the following steps.
performing first-stage cleaning by adding 100 g/t-200 g/t of collector A into the rougher concentrate, so as to obtain a cleaned concentrate I and a cleaned middling I; performing second-stage cleaning by adding 50 g/t-100 g/t of collector A into the cleaned concentrate I, so as to obtain a cleaned concentrate II and a cleaned middling II; and performing third-stage cleaning on the cleaned concentrate II, so as to obtain a copper concentrate and a cleaned middling III, wherein the cleaned middling II and the cleaned middling III return to the previous stage for re-cleaning.

In some embodiments of the present disclosure, in step S4, the cascade-intensified flotation includes:
performing three-time open-circuit roughing on the rougher tailings, so as to obtain an open-circuit rougher concentrate; and
performing flotation on the open-circuit rougher concentrate, so as to obtain the sulfur-containing tailings, wherein the flotation includes one-time roughing, two-time cleaning and three-time scavenging.

In some embodiments of the present disclosure, in step S4, the three-time open-circuit roughing includes: adding 10 g/t-80 g/t collector A for three-time open-circuit roughing; typically, but not limited to, for example, in step S4, the addition amount of collector A in the three-time open-circuit roughing process can be 10 g/t, 20 g/t, 30 g/t, 40 g/t, 50 g/t, 60 g/t, 70 g/t, 80 g/t, or a range value composed of any two thereof.

In some embodiments of the present disclosure, in step S4, the one-time roughing includes: adding 10 g/t-35 g/t activator and 50 g/t-150 g/t butyl xanthate for the one-time roughing; and the three-time scavenging includes: adding 10 g/t-50 g/t butyl xanthate for the three-time scavenging.

In some embodiments of the present disclosure, in step S4, the cascade-intensified flotation includes the following steps:
performing the first-stage open-circuit roughing by adding 70 g/t-80 g/t of collector A into the rougher tailings, so as to obtain the open-circuit rougher concentrate I and the open-circuit rougher tailings I; performing the second-stage open-circuit roughing by adding 50 g/t-60 g/t of collector A into the open-circuit rougher tailings I, so as to obtain the open-circuit rougher concentrate II and the open-circuit rougher tailings II; performing the third-stage open-circuit roughing by adding 10 g/t-30 g/t of collector A into the open-circuit rougher tailings II, so as to obtain the open-circuit rougher concentrate III and the open-circuit rougher tailings III; and mixing the open-circuit rougher concentrate I, the open-circuit rougher concentrate II and the open-circuit rougher concentrate III to obtain the open-circuit rougher concentrate;
performing one-time roughing by adding 10 g/t-35 g/t activator and 50 g/t-150 g/t butyl xanthate (collector) into the open-circuit rougher concentrate, so as to obtain the rougher concentrate IV and the rougher tailings IV;
performing first-stage cleaning on the rougher concentrate IV to obtain the cleaned concentrate V and the cleaned middling V; and performing second-stage cleaning on the cleaned concentrate V to obtain the cleaned concentrate VI and the cleaned middling VI; and
performing first-stage scavenging by adding 10 g/t-50 g/t of butyl xanthate into the cleaned concentrate VI, so as to obtain the scavenging middling VII and the scavenging tailings VII; performing second-stage scavenging by adding 10 g/t-50 g/t of butyl xanthate into the scavenging tailings VII, so as to obtain the scavenging middling VIII and the scavenging tailings VIII; and performing third-stage scavenging by adding 10 g/t-50 g/t of butyl xanthate into the scavenging tailings VIII, so as to obtain the scavenging middling IX and the scavenging tailings IX, wherein the scavenging tailings IX is the sulfur-containing tailings.

In some embodiments of the present disclosure, in step S4, the activator includes but is not limited to copper sulfate.

In the method of flotation separation for copper-sulfur polymetallic ore according to the present disclosure, the addition amount of each reagent is the mass of the reagent added per ton of ore slurry.

### Example 1

The method of flotation separation for copper-sulfur polymetallic ore provided in the present example includes the following steps.
S1, a copper-sulfur polymetallic ore was adopted as the raw ore, wherein the metallic minerals included chalcopyrite and pyrite, and gangue ores included quartz and mica. In the raw ore, the average grade of copper was 0.4%, the average grade of sulfur was 1.6%, and the average grade of iron was 2.0%.

The semi-autogenous grinding for 0.15h, and stage grinding or ball milling for 0.2h were performed on the raw ore in turn, so as to obtain the ground ore material, wherein
the proportion of particles with particle size less than 0.074 mm in the ground ore material was 65 wt %; and in the ground ore material, the exposure ratio of 112 facet of chalcopyrite was 57%, the exposure ratio of 204 facet was 8%, the exposure ratio of 312 facet was 5%, and the exposure ratio of 100 facet of pyrite was 63%.
S2, water was added into the ground ore material to adjust the mass concentration of the slurry to 30 wt %, the lime was added to adjust the pH to 7, and then 1200 g/t collector A, 500 g/t depressant B and 20 g/t pine oil were added for one-time roughing, so as to obtain the rougher concentrate and the rougher tailings.
S3, 150 g/t of collector A was added into the rougher concentrate for first-stage cleaning, so as to obtain the cleaned concentrate I and the cleaned middling I; 50 g/t of collector A was added into the cleaned concentrate I for second-stage cleaning, so as to obtain the cleaned concentrate II and the cleaned middling II; third-stage cleaning was performed on the cleaned concentrate II to obtain the copper concentrate and the cleaned middling III, wherein the cleaned middling II and the cleaned middling III returned to the previous stage for re-cleaning.
S4, first-stage open-circuit roughing was performed by adding 70 g/t of collector A into the rougher tailings to obtain the open-circuit rougher concentrate I and the open-circuit rougher tailings I; second-stage open-circuit roughing was performed by adding 50 g/t of collector A into the open-circuit rougher tailings I to obtain the open-circuit rougher concentrate II and the open-circuit rougher tailings II; third-stage open-circuit roughing was performed by adding 15 g/t of collector A into the open-circuit rougher tailings II to obtain the open-circuit rougher concentrate III and the open-circuit rougher tailings III; and the open-circuit rougher concentrate I, the open-circuit rougher concentrate II and the open-circuit rougher concentrate III were mixed to obtain the open-circuit rougher concentrate.

One-time roughing was performed by adding 20 g/t activator copper sulfate and 100 g/t collector butyl xanthate into the open-circuit rougher concentrate, so as to obtain the rougher concentrate IV and the rougher tailings IV.

The first-stage cleaning was performed on the rougher concentrate IV to obtain the cleaned concentrate V and the cleaned middling V; and second-stage cleaning was performed on the cleaned concentrate V to obtain the cleaned concentrate VI and the cleaned middling VI.

The first-stage scavenging was performed by adding 20 g/t of butyl xanthate into the cleaned concentrate VI, so as to obtain the scavenging middling VII and the scavenging tailings VII; the second-stage scavenging was performed by adding 20 g/t of butyl xanthate into the scavenging tailings VII, so as to obtain the scavenging middling VIII and the scavenging tailings VIII; the third-stage scavenging was performed by adding 10 g/t of butyl xanthate into the scavenging tailings VIII, so as to obtain the scavenging middling IX and the scavenging tailings IX (sulfur-containing tailings), wherein
the collector A included

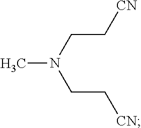

and
the depressant B included sodium cyanamide, sodium dicyandiamide, sodium polycyanamide (molecular weight of 1000-1500) and sodium polysulfide in the mass ratio of 2:10:3:1.5.

### Example 2

The method of flotation separation for copper-sulfur polymetallic ore provided in the present example includes the following steps.
S1, a copper-sulfur polymetallic ore was adopted as the raw ore, wherein the metallic minerals included chalcopyrite and pyrite, and gangue ores included quartz and mica. In the raw ore, the average grade of copper was 0.4%, the average grade of sulfur was 1.6%, and the average grade of iron was 2.0%.

The semi-autogenous grinding for 0.17h, and stage grinding or ball milling for 0.23h were performed on the raw ore in turn, so as to obtain the ground ore material, wherein
the proportion of particles with particle size less than 0.074 mm in the ground ore material was 69 wt %; and in the ground ore material, the exposure ratio of 112 facet of chalcopyrite was 62%, the exposure ratio of 204 facet was 13%, the exposure ratio of 312 facet was 8%, and the exposure ratio of 100 facet of pyrite was 75%.
S2, water was added into the ground ore material to adjust the mass concentration of the slurry to 30 wt %, the lime was added to adjust the pH to 7, and then 1500 g/t collector A, 1000 g/t depressant B and 25 g/t pine oil were added for one-time roughing, so as to obtain the rougher concentrate and the rougher tailings.
S3, 200 g/t of collector A was added into the rougher concentrate for first-stage cleaning, so as to obtain the cleaned concentrate I and the cleaned middling I; 100 g/t of collector A was added into the cleaned concentrate I for second-stage cleaning, so as to obtain the cleaned concentrate II and the cleaned middling II; third-stage cleaning was performed on the cleaned concentrate II to obtain the copper concentrate and the cleaned middling III, wherein the cleaned middling II and the cleaned middling III returned to the previous stage for re-cleaning.
S4, first-stage open-circuit roughing was performed by adding 80 g/t of collector A into the rougher tailings to obtain the open-circuit rougher concentrate I and the open-circuit rougher tailings I; second-stage open-circuit roughing was performed by adding 60 g/t of collector A into the open-circuit rougher tailings I to obtain the open-circuit rougher concentrate II and the open-circuit rougher tailings II; third-stage open-circuit roughing was performed by adding 30 g/t of collector A into the open-circuit rougher tailings II to obtain the open-circuit rougher concentrate III and the open-circuit rougher tailings III; and the open-circuit rougher concentrate I, the open-circuit rougher concentrate II and the open-circuit rougher concentrate III were mixed to obtain the open-circuit rougher concentrate.

One-time roughing was performed by adding 30 g/t activator copper sulfate and 150 g/t collector butyl xanthate into the open-circuit rougher concentrate, so as to obtain the rougher concentrate IV and the rougher tailings IV.

First-stage cleaning was performed on the rougher concentrate IV to obtain the cleaned concentrate V and the cleaned middling V; and second-stage cleaning was performed on the cleaned concentrate V to obtain the cleaned concentrate VI and the cleaned middling VI.

The first-stage scavenging was performed by adding 40 g/t of butyl xanthate into the cleaned concentrate VI, so as to obtain the scavenging middling VII and the scavenging tailings VII; the second-stage scavenging was performed by adding 40 g/t of butyl xanthate into the scavenging tailings VII, so as to obtain the scavenging middling VIII and the scavenging tailings VIII; the third-stage scavenging was performed by adding 20 g/t of butyl xanthate into the scavenging tailings VIII, so as to obtain the scavenging middling IX and the scavenging tailings IX (sulfur-containing tailings), wherein
the collector A included

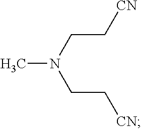

and
the depressant B included sodium cyanamide, sodium dicyandiamide, sodium polycyanamide (molecular weight of 1000-1500) and sodium polysulfide in the mass ratio of 3:12:6:2.

### Example 3

The method of flotation separation for copper-sulfur polymetallic ore provided in the present example includes the following steps.
S1, a copper-sulfur polymetallic ore was adopted as the raw ore, wherein the metallic minerals included chalcopyrite and pyrite, and gangue ores included quartz and mica. In the raw ore, the average grade of copper was 0.4%, the average grade of sulfur was 1.6%, and the average grade of iron was 2.0%.

The semi-autogenous grinding for 0.15h, and stage grinding or ball milling for 0.18h were performed on the raw ore in turn, so as to obtain the ground ore material, wherein
the proportion of particles with particle size less than 0.074 mm in the ground ore material was 62 wt %; and in the ground ore material, the exposure ratio of 112 facet of chalcopyrite was 55%, the exposure ratio of 204 facet was 5%, the exposure ratio of 312 facet was 3%, and the exposure ratio of 100 facet of pyrite was 60%.
S2, water was added into the ground ore material to adjust the mass concentration of the slurry to 30 wt %, the lime was added to adjust the pH to 7, and then 1000 g/t collector A, 300 g/t depressant B and 15 g/t pine oil were added for one-time roughing, so as to obtain the rougher concentrate and the rougher tailings.
S3, 120 g/t of collector A was added into the rougher concentrate for first-stage cleaning, so as to obtain the cleaned concentrate I and the cleaned middling I; 50 g/t of collector A was added into the cleaned concentrate I for second-stage cleaning, so as to obtain the cleaned concentrate II and the cleaned middling II; third-stage cleaning was performed on the cleaned concentrate II to obtain the copper concentrate and the cleaned middling III, wherein the cleaned middling II and the cleaned middling III returned to the previous stage for re-cleaning.
S4, first-stage open-circuit roughing was performed by adding 70 g/t of collector A into the rougher tailings to obtain the open-circuit rougher concentrate I and the open-circuit rougher tailings I; second-stage open-circuit roughing was performed by adding 50 g/t of collector A into the open-circuit rougher tailings I to obtain the open-circuit rougher concentrate II and the open-circuit rougher tailings II; third-stage open-circuit roughing was performed by adding 10 g/t of collector A into the open-circuit rougher tailings II to obtain the open-circuit rougher concentrate III and the open-circuit rougher tailings III; and the open-circuit rougher concentrate I, the open-circuit rougher concentrate II and the open-circuit rougher concentrate III were mixed to obtain the open-circuit rougher concentrate.

One-time roughing was performed by adding 15 g/t activator copper sulfate and 80 g/t collector butyl xanthate into the open-circuit rougher concentrate, so as to obtain the rougher concentrate IV and the rougher tailings IV.

First-stage cleaning was performed on the rougher concentrate IV to obtain the cleaned concentrate V and the cleaned middling V; and second-stage cleaning was performed on the cleaned concentrate V to obtain the cleaned concentrate VI and the cleaned middling VI.

The first-stage scavenging was performed by adding 20 g/t of butyl xanthate into the cleaned concentrate VI, so as to obtain the scavenging middling VII and the scavenging tailings VII; the second-stage scavenging was performed by adding 20 g/t of butyl xanthate into the scavenging tailings VII, so as to obtain the scavenging middling VIII and the scavenging tailings VIII; the third-stage scavenging was performed by adding 10 g/t of butyl xanthate into the scavenging tailings VIII, so as to obtain the scavenging middling IX and the scavenging tailings IX (sulfur-containing tailings), wherein
the collector A included

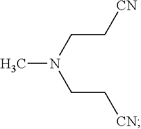

and
the depressant B included sodium cyanamide, sodium dicyandiamide, sodium
polycyanamide (molecular weight of 1000-1500) and sodium polysulfide in the mass ratio of 2:8:3:1 (4:16:6:2).

### Comparative Example 1

The method of flotation separation for copper-sulfur polymetallic ore provided by the present comparative example was referred to Example 1, and the only difference was that in step S1, the raw ore was crushed and screened to-10 mm accounting for 95 wt %, and then ball-milled for 0.2h to obtain the ground ore material. The proportion of particles with particle size less than 0.074 mm in the ground ore material was 62 wt %; and in the ground ore material, the exposure ratio of 112 facet of chalcopyrite was 53%, the exposure ratio of 204 facet was 7%, the exposure ratio of 312 facet was 5%, and the exposure ratio of 100 facet of pyrite was 55%.

### Comparative Example 2

The method of flotation separation for copper-sulfur polymetallic ore provided by the present comparative example was referred to Example 1, and the only difference was that the collector A was ethyl thionocarbamate and the depressant B was lime.

### Test Example 1

In the method of flotation separation for copper-sulfur polymetallic ore in Examples 1-3 and Comparative Examples 1-2, the average grades and recovery rates of copper and sulfur are shown in Table 1.

TABLE 1

| | Copper concentrate | | Sulfur-containing tailings | |
|---|---|---|---|---|
| | Average grade of | Recovery rate | Average grade | Recovery rate |
| | copper (%) | of copper (%) | of sulfur (%) | of sulfur (%) |
| Example 1 | 24.5 | 88.3 | 48.5 | 67.5 |
| Example 2 | 25.2 | 89.5 | 48.7 | 68.1 |
| Example 3 | 24.0 | 87.8 | 47.8 | 65.3 |
| Comparative | 23.7 | 86.3 | 47.5 | 63.2 |
| Example 1 | | | | |
| Comparative | 23.1 | 85.2 | 48.3 | 60.5 |
| Example 2 | | | | |

Finally, it should be explained that the above examples are only configured to illustrate the technical solutions of the present disclosure, but not to limit it. Although the present disclosure has been described in detail with reference to the foregoing examples, it should be understood by those skilled in the art that the technical solutions described in the foregoing examples can still be modified, or some or all of its technical features can be replaced by equivalents; however, these modifications or substitutions do not make the essence of the corresponding technical solutions deviate from the scope of the technical solutions of various examples of the present disclosure.

1. A method of flotation separation for copper-sulfur polymetallic ore, comprising following steps:
S1, performing an ore grinding treatment on a raw ore, so as to obtain a ground ore material, wherein in the ground ore material, an exposure ratio of 112 facet of chalcopyrite is 55%-65%, an exposure ratio of 204 facet is 5%-18%, an exposure ratio of 312 facet is 3%-10%, and an exposure ratio of 100 facet of pyrite is 60%-80%;
S2, performing a slurry conditioning and a pH adjustment on the ground ore material in sequence, then adding a collector A, a depressant B and a frother into a resultant for a one-time roughing, so as to obtain a rougher concentrate and a rougher tailings;
S3, mixing the rougher concentrate and the collector A and carrying out a multiple-time cleaning, so as to obtain a copper concentrate; and
S4, performing a cascade-intensified flotation on the rougher tailings, so as to obtain a sulfur-containing tailings, wherein
the collector A comprises 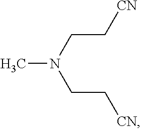
and
the depressant B comprises a sodium cyanamide, a sodium dicyandiamide, a sodium polycyanamide and a sodium polysulfide.

2. The method of flotation separation for copper-sulfur polymetallic ore according to claim 1, wherein in step S1, in the raw ore, an average grade of copper is 0.2%-0.6%, and an average grade of sulfur is 1%-2%.

3. The method of flotation separation for copper-sulfur polymetallic ore according to claim 1, wherein in step S1, the ore grinding treatment comprises performing a first-stage ore grinding treatment and a second-stage ore grinding treatment in sequence, wherein the first-stage ore grinding treatment comprises a semi-autogenous grinding, and the second-stage ore grinding treatment comprises a ball milling and/or a stage grinding.

4. The method of flotation separation for copper-sulfur polymetallic ore according to claim 1, wherein in step S2, a mass ratio of the sodium cyanamide, the sodium dicyandiamide, the sodium polycyanamide and the sodium polysulfide is (1-5):(10-17):(2-7):(1-2).

5. The method of flotation separation for copper-sulfur polymetallic ore according to claim 1, wherein in step S2, during the one-time roughing process, an addition amount of the collector A is 1000 g/t-2000 g/t, and an addition amount of the depressant B is 50 g/t-1500 g/t.

6. The method of flotation separation for copper-sulfur polymetallic ore according to claim 1, wherein in step S3, the multiple-time cleaning comprises a three-time cleaning or a four-time cleaning.

7. The method of flotation separation for copper-sulfur polymetallic ore according to claim 6, wherein in step S3, an addition amount of the collector A in a first-stage cleaning and a second-stage cleaning of the multiple-time cleaning is each independently 50 g/t-200 g/t.

8. The method of flotation separation for copper-sulfur polymetallic ore according to claim 1, wherein in step S4, the cascade-intensified flotation comprises:
performing a three-time open-circuit roughing on the rougher tailings, so as to obtain an open-circuit rougher concentrate; and
performing a flotation on the open-circuit rougher concentrate, so as to obtain the sulfur-containing tailings, wherein the flotation comprises an one-time roughing, a two-time cleaning and a three-time scavenging.

9. The method of flotation separation for copper-sulfur polymetallic ore according to claim 8, wherein in step S4, the three-time open-circuit roughing comprises: adding 10 g/t-80 g/t of the collector A to perform the three-time open-circuit roughing.

10. The method of flotation separation for copper-sulfur polymetallic ore according to claim 8, wherein in step S4, the one-time roughing comprises: adding 10 g/t-35 g/t activator and 50 g/t-150 g/t butyl xanthate to perform the one-time roughing; and the three-time scavenging comprises adding 10 g/t-50 g/t butyl xanthate to perform three-time scavenging.
